(19) United States
(12) Patent Application Publication
(10) Pub. No.: US 2003/0033374 A1
(43) Pub. Date: Feb. 13, 2003

(54) Method and system for implementing a communications core on a single programmable device

(75) Inventors: Al Horn, Albuquerque, NM (US); John Cunningham, San Diego, CA (US); John Schulte, Santa Barbara, CA (US); Richard Wade, Albuquerque, NM (US); Timothy Uhl, Goleta, CA (US)

Correspondence Address: Derek C. Stettner, Michael Best & Friedrich LLP, 100 East Wisconsin Avenue, Milwaukee, WI, 53202-4108, US

(73) Assignee: Condor Engineering, inc., Santa Barbara, CA (US)

(21) Appl. No.: 10/202,180

(22) Filed: Jul. 24, 2002

Related U.S. Application Data
(60) Provisional application No. 60/307,624, filed on Jul. 24, 2001.

(51) Int. Cl. G06F 15/16

(52) U.S. Cl. 709/217; 709/227; 709/230; 709/253

(57) ABSTRACT

A communications core implemented on a single programmable device. In one embodiment, the communications core may include a subsystem interconnect operable to connect the programmable device to computer; a message processor coupled to the subsystem interconnect, the message processor having an instruction set architecture that includes a data path configured to reduce hardware requirements and increase memory management capabilities; and a codec coupled to the message processor. The programmable device may also include an instruction data buffer coupled to the message processor; and a signal conditioner coupled to the codec.

### RELATED APPLICATIONS

This application claims the benefit of co-pending U.S. Provisional Application No. 60/307,624, filed on Jul. 24, 2001.

### FIELD OF THE INVENTION

The present invention relates to a method and system for implementing a communications core on a programmable device.

### BACKGROUND OF THE INVENTION

In aviation electronics (or avionics) and similar areas (such as vehicle electronics and even office information systems using local area networks) there is a need for multiple devices to exchange data. Military Standard 1553 (“MIL-STD-1553,” the “1553 standard,” or “1553”) defines a data bus protocol for devices (or terminals) to communicate with one another on a shielded, twisted pair of wires. The 1553 standard was first used in the U.S.'s F-16 fighter jet. The 1553 standard and its progeny (known as Notice 1 and Notice 2) have been applied to a variety of civilian and military systems.

The 1553 standard is designed to facilitate communication in systems having one or more instantiations of three elemental hardware devices or terminals: remote terminals, bus controllers, and bus monitors. It is assumed that the elemental devices communicate with one another via a transmission media that includes a main bus and a number of offshoots or stubs. As noted, the transmission media used in the main bus and stubs is a twisted pair transmission line.

Remote terminals are defined as all terminals not operating as the bus controller or as a bus monitor (both of which are defined below). A remote terminal includes electronics necessary to transfer data between the data bus and a subsystem. The subsystem is the sender or user of data being transferred on the bus. Subsystems generally include a sensor and a device for converting analog and discrete data to and from a data format compatible with the data bus. A remote terminal, or more broadly a “terminal,” may include a transceiver, an encoder/decoder (“codec”), a protocol controller, a buffer or memory, and a subsystem interface.

Bus controllers direct the flow of data on the data bus. Although a particular system implemented using the 1553 standard may include multiple bus controllers or terminals capable performing bus control functions, only one bus controller may be active at a time. In addition, only a bus controller may issue commands on the data bus. The commands may include commands requiring the transfer of data or commands to control and manage the bus, which are referred to as mode commands. Bus controllers are typically implemented as one of three types of controllers: a word controller, a message controller, or a frame controller.

A bus monitor is a terminal that listens to or monitors the exchange of information on the data bus. The monitor may collect all the data exchanged on the bus or it may collect selected data according to predetermined criteria. Generally, bus monitors fall into one of two categories: a recorder for testing or a terminal functioning as a backup bus controller. When collecting data, the bus monitor must perform the same message validation functions as remote terminals and, if an error is detected, inform the necessary subsystems of the error. FIG. 1 includes a high-level schematic of an electronic system implemented using the 1553 standard.

Terminals implemented in 1553 systems include a variety of components ranging from discrete devices to computers and other programmable devices. In many 1553 systems, terminals are implemented using one or more application specific integrated circuits (“ASICs”) (which are generally not programmable or at least not re-programmable), memory devices (e.g., various ROM and RAM or other memory), and programmable logic devices (“PLDs”) (which as their name implies are generally re-programmable). PLDs do not, in general, have all of the functionality of general-purpose microprocessors, but they offer the flexibility of being re-programmable, are relatively inexpensive, and provide greater efficiency in many circumstances in comparison to microprocessors. Programmable array logic (“PAL”) devices and field programmable gate array (“FPGA”) devices are two examples of the many types of PLDs available.

### SUMMARY OF THE INVENTION

While terminals implemented using multiple components (e.g. ASICS, PLDs, and RAM) are functional, they are not completely satisfactory. Generally, the higher the number of components in a terminal, the higher and more complicated the testing requirements become. Further, as the number of components increases, reliability decreases. Further still, the internal speed of a terminal will generally decrease as the number of components increases, because data must travel between or among the multiple components of the terminal before being processed or transmitted to the data bus and any connected subsystems. Large size is another disadvantage of multiple component terminals. Generally, terminals include one or more circuit boards with each component mounted on such boards. ASICs, PLDs, RAM, and other components required for a multiple component terminal, as well as the connections between the components, inherently possess physical space limitations. As compared to a single component capable of performing multiple functions, a terminal having multiple components will, in general, be much larger. In addition, as compared to a component capable of performing multiple functions, a multiple-component terminal will, in general, generate a greater amount of heat.

Accordingly, the inventors have determined that it would be beneficial to implement a communications core on a single device and have invented several new technologies to permit such an implementation. In one embodiment, the invention provides a PLD that may be used to implement a communications core. In addition, a signal conditioner, which is external to the PLD, may be implemented. The signal conditioner modifies or conditions raw network or data bus signals to a format that is compatible with other avionics components, such as a computer. The signal conditioner may include active analog and digital conditioning components, as well as passive components such as transformers, diodes, and capacitors. The passive components may be used to protect board level components or the data bus network from noise, electrical shorts, or voltage spikes. The signal conditioner may also include discrete component(s) and/or circuits (such as ASIC transceiver chips, including, fiber optic transmitters, receivers, RS-485 transceivers, 1553 transceivers, etc.) to isolate and condition voltage potentials, digital signals, and noise from computer-based subsystems. Use of a signal conditioner is optional in some embodiments of the invention. If the bus or network signals match the PLD input/output electrical characteristics, then the signal could be routed directly to other components in the communication core without conditioning.

The PLD may include an encoder/decoder (or “codec”). In one embodiment, the codec performs bit and word level protocol field construction for transmission or reception onto the data bus. In some embodiments, the codec may be treated as a serial to parallel converter (for decoding, or bit recovery for deciphering of a digital bit from a raw transmission signal), or parallel to serial converter (for encoding). The codec may also perform bit and word level validation of network or data bus characteristics such as bit encoding and word level synchronization, gap timing, parity, and check-sum verification. The codec, which may be implemented in software, may be modified to allow the communication core to operate different avionics or network interfaces. The codec may also be duplicated within the communication core to support multiple or redundant bus topologies.

The PLD may also include a message processor. In one embodiment the message processor constructs and processes message packets. The message processor may append, remove, and control overhead words for data bus communications, allowing data to be transmitted reliably between computers coupled to the data bus.

Yet another component of the PLD may be a data and instruction memory. In one embodiment, the memory supports buffering for data bus/network data and processor instructions for the message processor.

The PLD may also include a subsystem interconnect. The subsystem interconnect connects components of the communication core to computer subsystem backplanes or processing buses, or simply to other interfaces in an avionics system or other computer. In one embodiment, the system interconnect provides an interconnect function between the data and instruction memory, the message processor, and a subsystem bus or backplane. The subsystem interconnect may perform arbitration between the memory, processor, and subsystem bus backplane of a computer connected to the communication core. The subsystem interconnect may also provide a timing circuit interface for time synchronization functions, discrete I/O controls for related data bus synchronization, or trigger input/output control.

In another embodiment, the invention provides a method of implementing a communications core. The method includes the steps of loading and integrating a communications core software on a PLD and programming functions for the communications core into the communication core.

The method may also include formatting or creating a communications core in an electronic design interchange format. Further still, the method may include programming functions through an application programming interface, determining an address offset where the communications core has been loaded, accessing file registers in a predetermined sequence to read and write data and status information.

Yet other features and embodiments of the invention will become apparent to persons of ordinary skill in the art after review of the drawings and description provided.

### BRIEF DESCRIPTION OF THE DRAWINGS

FIG. 1 illustrates an exemplary network with a plurality of terminals implemented using the 1553 standard according to one embodiment of the invention.

FIG. 2 illustrates a block diagram of an exemplary terminal according to one embodiment of the invention.

FIG. 3 depicts a data-flow schematic between a codec and a processing circuit in one embodiment of the invention.

FIG. 4 illustrates data-flow between a message processor and a database in one embodiment of the invention.

FIG. 5 illustrates data-flow associated with a subsystem interconnect in one embodiment of the invention.

FIG. 6 illustrates data-flow associated with a processor in the message processor in one embodiment of the invention.

FIG. 7 depicts a schematic diagram of a data path for the message processor according to one embodiment of the invention.

FIG. 8 illustrates a schematic diagram of a data path associated with a memory manager or management module according to one embodiment of the invention.

FIG. 9 illustrates an exemplary design flow for implementing a communications core on a programmable device according to one embodiment of the invention.

FIG. 10 illustrates an exemplary design entry step associated with the exemplary design flow for implementing a communications core on a programmable device.

FIG. 11 illustrates an exemplary implementation step associated with the exemplary design flow for implementing a communications core on a programmable device.

FIG. 12 illustrates an exemplary programming step associated with the exemplary design flow for implementing a communications core on a programmable device.

FIG. 13 illustrates an exemplary implementation process of a communications core with FPGA devices using synthesis software.

FIG. 14 illustrates an exemplary implementation process of a communications core with CPLD devices using synthesis software.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

Before embodiments of the software modules are described in detail, it should be noted that the invention is not limited to the software language described or implied in the figures and that a variety of alternative software languages may be used for implementation and programming of the invention. In addition, the specific interconnection types and names illustrated in the figures are merely exemplary. A plurality of connection configurations may be implemented for use with the invention, including a subset of or additional interconnections between elements. Further, it is currently preferred that embodiments of the invention be constructed to implement the 1553 standard. However, other protocols such as MIL-STD-1773 (the “1773 protocol”), STAGNAG-3910/3838, ARINC-708, EBR-1553, ARINC-664, ARINC-429, ARINC-629, RS-232, RS-422, RS-485, IEEE-488, GPIB, HPIB, and HPIL may be used.

It should also be understood that many components and items (e.g., the communications core 112) are illustrated and described as if they were hardware, as is common practice within the art. However, one of ordinary skill in the art, and based on a reading of this detailed description, would understand that, in at least one embodiment, the components are actually software. Furthermore, although software implementations are generally preferred, it should be understood that it is possible to implement various components in hardware.

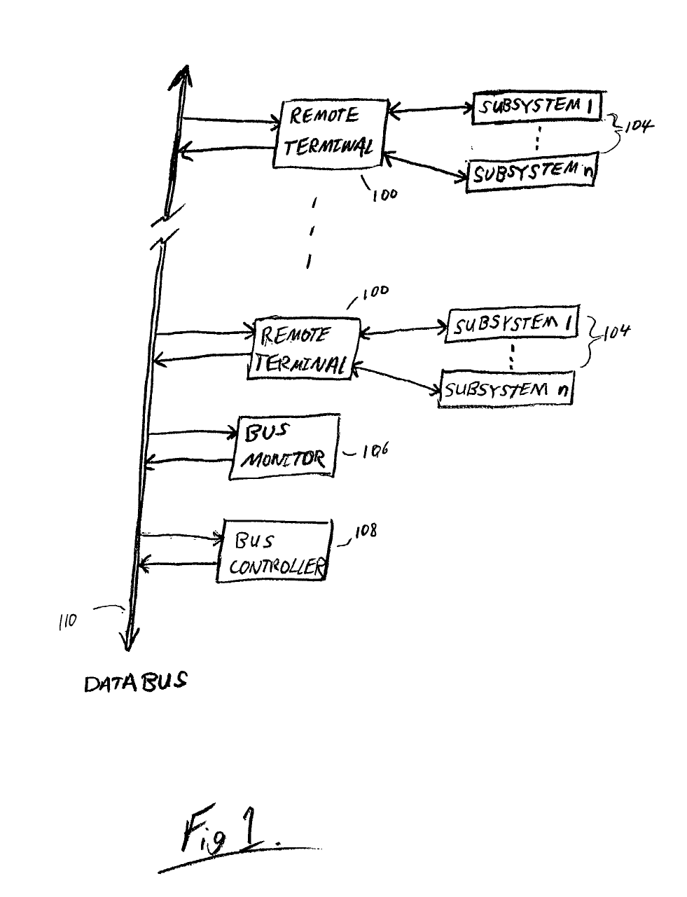

As illustrated in FIG. 1, one embodiment of the invention may include a plurality of terminals 100, a plurality of subsystems 104, a bus monitor 106, a bus controller 108, and a transmission media or data bus 110. The subsystems 104 are the senders or users of the data being transferred on data bus 110. For example, a subsystem 104 may include an avionics computer system or processing bus coupled to various sensors or devices that may provide and respond to data transferred on data bus 110. As will be discussed in greater detail, the data bus 110 may support bi-directional data or be configured with a separate read bus and a separate write bus. The terminals 100 provide the necessary electronics and processing to transfer data between one or more data buses, such as data bus 110, and a subsystem 104. The bus monitor 106 “listens” to the transfer of information over the data bus 110 and may act as a passive device that does not report on the status of the information transferred. The bus monitor 106 may collect all, or a selected portion of, the data from the data bus 110 for purposes of recording transmission events, or to function as a back-up bus controller (described below). Examples of applications utilizing monitored or collected data include flight test recording, maintenance recording, and mission analysis. The bus controller 108 directs the flow of data across the data bus 110 and, preferably, has the exclusive right to issue commands onto the data bus 110. Architectures for the bus controller 108 may include word controller, a message controller, and a frame controller.

A word controller transfers one word (e.g., an 16-bit segment of data) at a time to each subsystem in the network or system controlled by the controller. A word controller does not, in general, have buffering and validation capabilities. Therefore, if a word controller is used, validation and buffering capabilities must generally be implemented in each subsystem.

A message controller outputs single messages at a time and interfaces with other devices (such as a processing computer) only at the end of messages or when an error occurs. Message controllers generally rely on a processing computer to provide an indication of when a terminal coupled to the network or data bus has a message and a control word that identifies the type of message being sent. Examples include a remote-terminal to bus-controller (“RT-BC”) message and a remote-terminal to remote-terminal (“RT-RT”) message.

A frame controller is capable of processing multiple messages in a predetermined sequence. A frame controller constructs messages in packets or frames. Each frame usually includes identifying information (i.e., information that identifies the frame), message data (i.e., the data of interest), and error checking information. Command frames may include multiple messages that are executed in an order specified by the command frame. A frame controller may be configured to execute all messages in a command frame and then wait for a prompt before executing another command frame (often referred to as “single cycle” or “singular” mode). Alternatively, a frame controller may be configured to execute all command frames according to a predetermined cycle rate (often referred to a “continuous” or “simultaneous” mode). In one preferred embodiment of the invention, the bus controller is implemented as a frame controller.

The terminals 100 include the capability to transfer data between the data bus 110 and one or more subsystems 104. In addition, the remote terminals 100 may function as interfaces to the data bus 110 for other components rather than operating as a terminal, bus monitor, or bus controller.

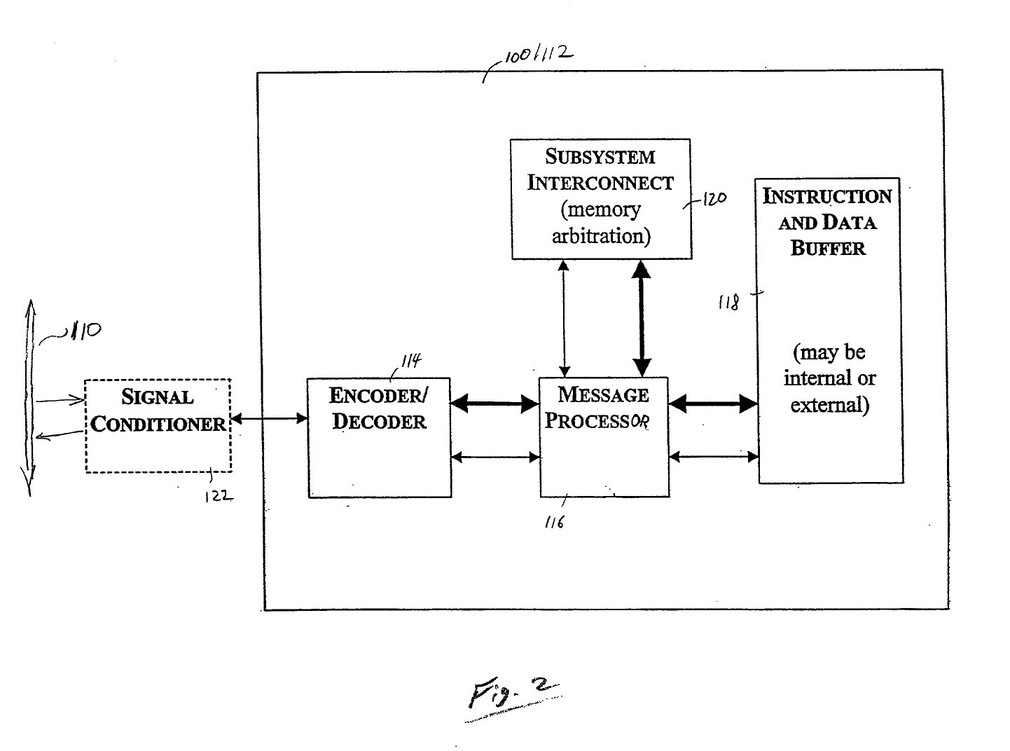

As noted above, the remote terminals 100 provide the information and processing interface between the data bus 110 and one or more subsystems 104. In one embodiment of the invention, a communications core 112 acts as a terminal 100 and is implemented on a single PLD as shown in FIG. 2. Suitable PLDs for use in creating an instantiation of the invention include the PLDs available from Xilinx under the Vitrex and Spartan trademarks including Field Programmable Gate Arrays (“FPGAs”), Complex Programmable Logic Devices (“CPLDs”), and more specifically the XPLA3, XC9500, XC17S00, and XC18V00 PLD families. The communications core 112 includes a codec 114, a message processor 116, an instruction and data buffer or memory 118, and a subsystem interconnect 120. In addition, an optional signal conditioner 122 may be coupled to the communications core 112 for augmenting signal integrity and ensuring contiguous data transmission between data bus 110 and terminal subsystems 104 that have various signal formats. In the exemplary embodiment shown, the codec 114 performs bit and word level field construction for transmission or reception of data onto or from the data bus 110. The codec 114 may also perform serial to parallel conversion for decoding (i.e., bit recovery for deciphering of a digital bit from a raw transmission signal) and parallel to serial conversion for encoding. The codec 114 may also perform clocking tasks, bit and word level validation, and network or data bus functions such as bit encoding and word level synchronization, gap timing, parity, and check-sum verification. The codec 114 and the signal conditioner 122 may be modified to allow the communications core 112 to operate on or with multiple different types of avionics or network interfaces. If desired, the codec 114 may be duplicated within the communications core 112 to support redundant bus topologies.

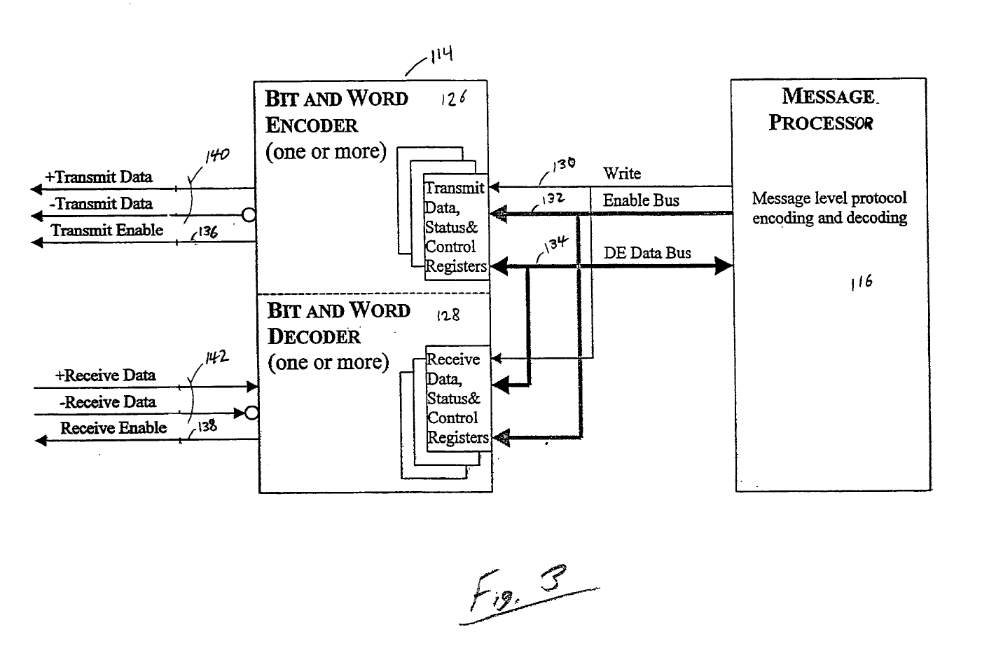

FIG. 3 illustrates the exemplary codec 114 in greater detail. In the embodiment shown, the codec includes an encoder 126 and decoder 128. The codec 114 communicates with the message processor and either the signal conditioner 122 or directly to the data bus 110. If used, the signal conditioner 122 may present data to the codec 114 in a plurality of forms including bipolar, differential, or single-ended data. The communication established between the codec 114 and the message processor 116 may occur on a write line 130, an enable bus 132, and/or a decode/encode (“DE”) data bus 134. Communication between the codec 114 and the data bus 110, or signal conditioner 122, may occur on transmit and receive lines, 136 and 138 respectively, and bipolar transmit and receive data paths, 140 and 142 respectively.

The message processor 116 constructs and processes message packets for use by a computer subsystem such as the subsystem 104. In one embodiment, the message processor 116 encapsulates raw subsystem data for orderly, reliable communications between devices coupled to the data bus 110. For example, when the message processor is implemented in accordance to the 1553 standard, the message processor implements 1553 message protocols. In other circumstances, the message processor may implement Open System Interconnect Level 3 and 4 network topologies. The message processor 116 appends, removes, and controls overhead words for data bus communications, allowing data to be transmitted between devices coupled to the data bus 110.

The instruction and data buffer 118 supports buffering for data bus and network data, and also supports processor instructions for the message processor 116. Unlike prior systems, the buffer 118 may be placed on the same PLD as the other components of the communications core 112. If addition memory is needed, the message processor 116 may couple the buffer 118 to memory that is external to the PLD.

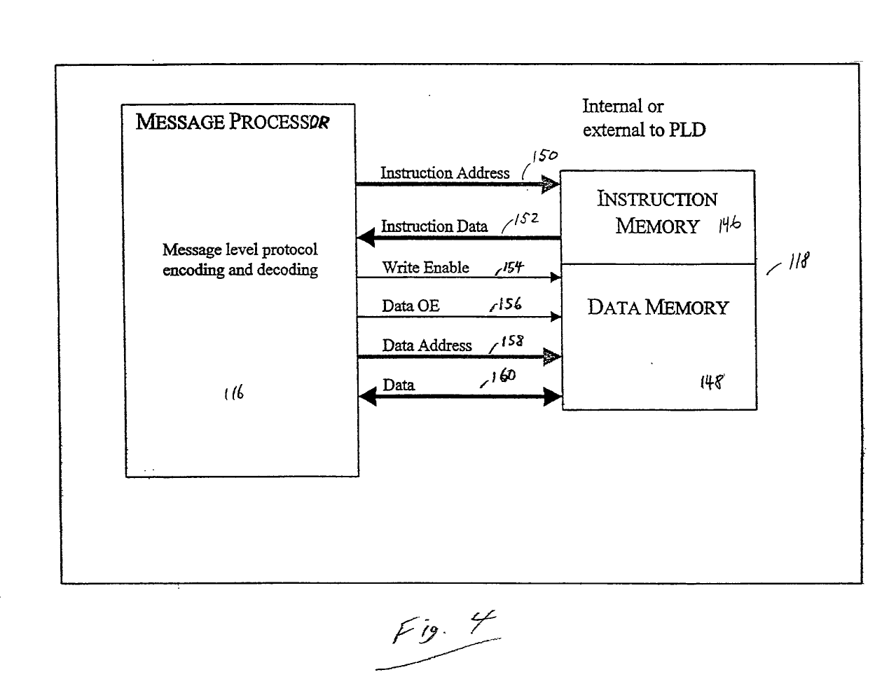

FIG. 4 illustrates an exemplary data interconnection scheme between the message processor 116 and the instruction and data buffer 118. In the embodiment shown in FIG. 4, the instruction and data buffer 118 may be considered as having two portions: instruction memory 146 and data memory 148. Instruction addresses are passed on an instruction address link 150. Instructions or, more broadly, instruction data associated with an address in the instruction memory 146 is passed back to the message processor 116 on data link 152. The data memory 148 receives write enable and data OE control signals on links 154 and 156, respectively. Data addresses are passed over communications link 158 and corresponding data exchanges may occur across memory data link 160.

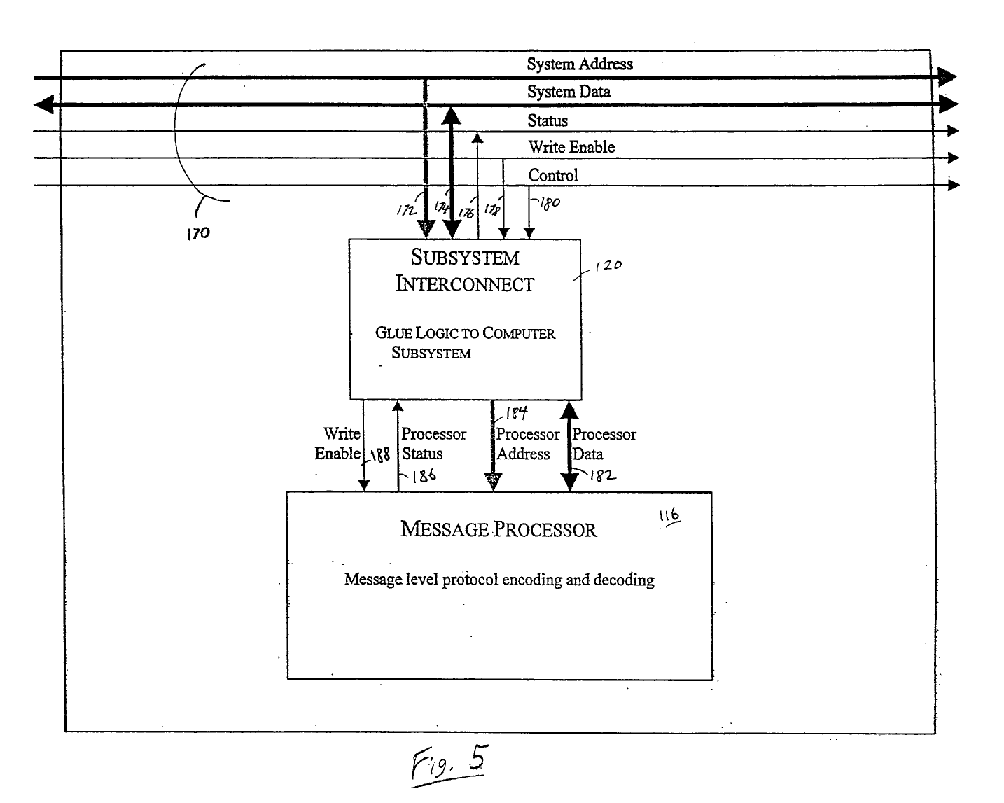

FIG. 5 provides additional details for an exemplary subsystem interconnect 120. As noted above, in some embodiments, the subsystem interconnect 120 couples the components of the communications core 112 to one or more subsystems 104, for example subsystem bus 170, additional processing buses (not shown), or to other interfaces or computers (not shown). In many instances, the subsystem interconnect 120 acts like “glue” logic or an arbitrator between the communications core 112 and the memory, processor, and the subsystem bus backplane of the computer or other component to which the subsystem interconnect 120 is coupled. The subsystem interconnect 120 may also provide the message processor 116 with a timing interface for discrete I/O controls for data bus synchronization, trigger input/output control, or other time synchronization functions. FIG. 5 illustrates an exemplary interconnection between a subsystem bus 170 and the message processor 116. The subsystem interconnect 120 includes communication paths to the subsystem 104 including a system address link 172, a system data link 174, a status link 176, a write enable link 178, and a control link 180. The subsystem interconnect 120 and the message processor 116 may communicate using a processor data link 182, a processor address link 184, a processor status link 186, and a write enable link 188.

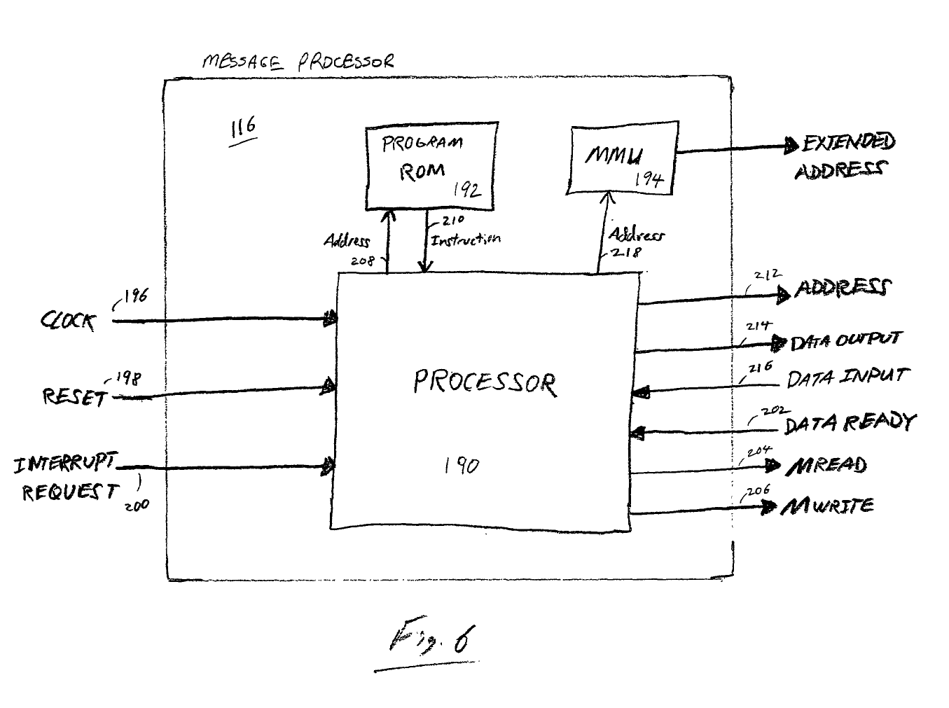

Additional details for an exemplary message processor 116 are provided in FIG. 6. As shown, the message processor 116 may include a processor 190, a program ROM 192, an optional memory management unit (“MMU”) 194, and a plurality of input/output connections. The processor 190 may receive control signals on a clock line 196, a reset line 198, a interrupt request line 200, and a data ready line 202, and may output control signals on an Mread line 204 and an Mwrite line 206. With reference to FIG. 4, the processor 190 may query the program ROM 192, which may be similar to instruction memory 146, by passing an address on address bus 208, which may be similar to link 150, and may receive the resulting instruction on instruction bus 210, which may be similar to link 152. The processor may also output data on an address line 212, which may be similar to link 158. The output data is receivable by memory such as data memory 148.

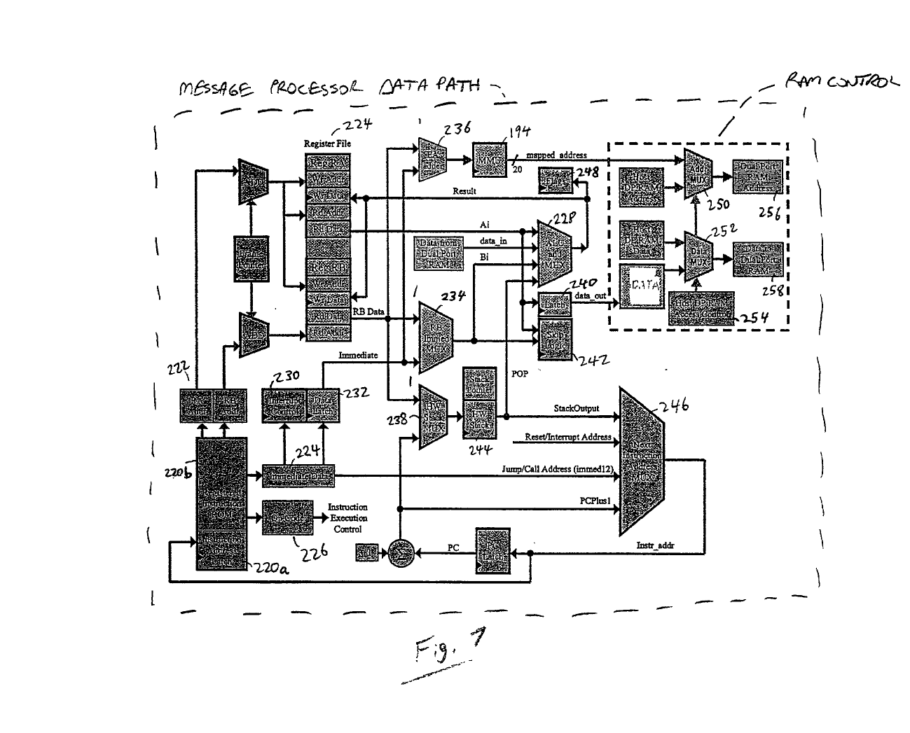

The MMU 194 (described further below) may be included in the message processor 116 to provide an interface to external memory (not shown). Briefly however, the MMU 194 receives an address from the processor 190 and the address is modified for routing to an extended address location within the optional external memory (not shown). As one example, during a load or store instruction, the processor 190 may request a data transfer from an external data link 216. The processor 190 outputs the memory address onto the address line 212, and also onto a mapped address bus 218, and asserts a signal on either the Mread line 204 or the Mwrite line 206. If the instruction is for storage, the processor 190 places the data on the data output bus 214. If the instruction is for loading information, the processor 190 expects data to be present on the data input bus 216. The processor 190 executes a “wait” routine until the data ready signal 202 becomes active or “high.” The data ready signal may be sampled at a frequency based on the clock signal 196 and, while the system waits for completion of an instruction, new instruction signals 210 from the program ROM 192 are blocked. As each instruction is completed, the processor 190 presents the address of the next instruction to be fetched on address bus 208. The program ROM 192 receives the address and returns the corresponding instruction on the instruction bus 210. The returned instruction is latched into an instruction register latch 220a (see FIG. 7) on the next pulse of the clock signal 196 unless the processor 190 is in the wait state described above.

As will be discussed in further detail, the processor is 190 is preferably implemented using a reduced instruction set computer (“RISC”) architecture. Generally, in a RISC architecture, software routines are generated to perform complex instructions that are performed in hardware in a complex instruction set computer (“CISC”); instruction size is kept constant; indirect addressing is prohibited; instructions are preferably designed to execute in one clock cycle or less; and instructions are not converted to microcode. In addition, it is also generally preferred that the processor 190 have an architecture with a reduced number of logical units. In one embodiment the processor 190 may be implemented using the Hummingbird processor available from Condor Engineering, assignee of the present application. When implemented according to the Hummingbird instantiation, the processor 190 is relatively small and fast (having about 450 or less logical units (currently approximately 444 logical units) and running at a clock speed of about 80 MHz or higher). In the currently preferred embodiment, the processor 190 is implemented using a Harvard architecture, has a 16-bit, non-pipelined design, which is scaleable to 32-bit data communication and addressing, and includes two sets of 16 bit general purpose registers for handling remote terminal messages. The registers may be quickly restored when hardware interrupts must be processed.

FIG. 7 illustrates an exemplary data path for the message processor 116. Execution of an instruction commences when a new instruction is fetched from the instruction ROM 192 as described above and shown as functional steps 220a,b in FIG. 7. The instruction is split into its constituent parts at step 222. An immediate operand 224 and operation code 226 are formed. The operation code 226 is operable to control instruction execution. Two register operands are fetched from a register file 224, one of which is input to an arithmetic logic unit and multiplexer (“ALU/MUX”) 228, a latch 240, and a skip logic module 242. The other register operand is input to an immediate multiplexer (“MUX”) 234, an address adder 236, and a stack MUX 238. The immediate operand 224 is input to an interrupt control 230 and data latch 232. The output of the data latch 232 is input to the immediate MUX 234 and the address adder 236. The selected output of the immediate MUX 234 is input to the ALU/MUX function 228 and to the skip logic module 242. The stack MUX 238 selects an output for the hardware stack 244, and the stack output (i.e., push-pop stack) is routed to the ALU/MUX 228 and a next instruction address MUX 246. The selected output of the ALU/MUX 228 is conditionally written back into the register file 224 and the flags 248 are updated. Output from the address adder 236 is input to the MMU 194, which provides the address for accessing the optional external memory. Latch 240 provides a data output path coupled to the optional external memory. The skip logic module 242 compares the instruction operands and sets or clears a “skip next instruction” register. As described above, during load and store instructions, the external data bus signals are driven and the processor 190 waits for the data ready signal 202. The address from the MMU 194 and the output data on bus 214 are presented to the external memory depending on whether the instruction is a read or a write instruction. In the example data path shown in FIG. 7, the external memory is depicted as RAM, however, one skilled in the art will understand that alternative means of data storage may also be used.

The address from the MMU 194 and output data from latch 240 are input to an address MUX 250 and data MUX 252, respectively. A host address and data are also input to the respective multiplexers 250 and 252, and a host access control 254 selects an output address 256 and output data 258. Data from the optional external memory, shown in this example as dual port RAM, is input to the ALU/MUX 228. The output of next instruction address MUX 246 is either the current instruction address plus 1, the immediate address specified by a call or jump, or the return address from the stack.

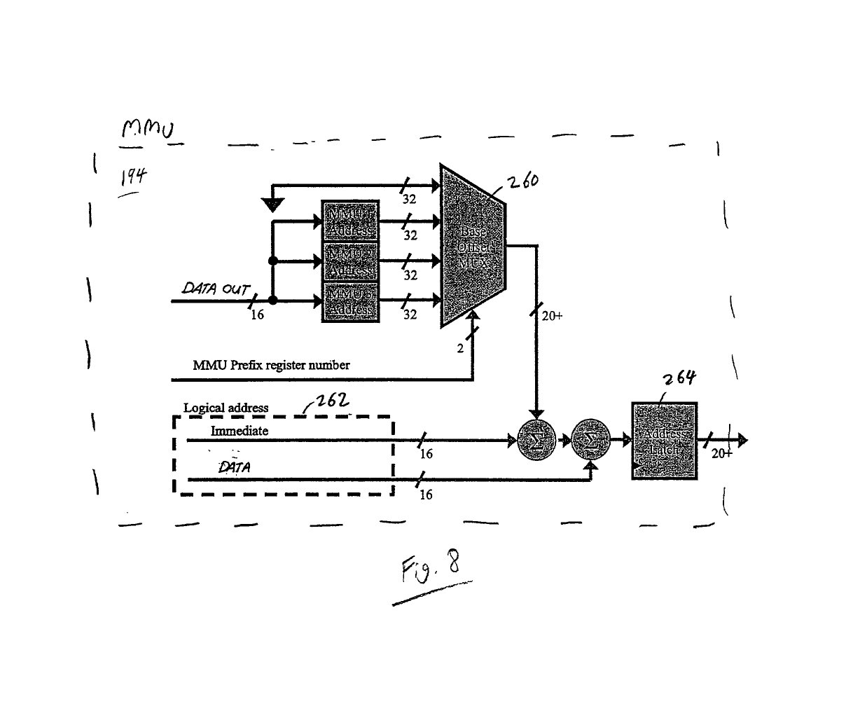

An exemplary functional block diagram of a memory management unit, such as MMU 194, is shown in FIG. 8. In one embodiment of the invention, the MMU 194 acts as a hardware extension to the processor 190 architecture that enables the processor 190 to access external memory. With reference to FIG. 8, the MMU 194 includes three mapping regions, MMU1, MMU2, and MMU3, and each region may access memory using a base address specified in a base address register that, in one embodiment, is up to 32-bits wide. These registers may optionally be used by LOAD and STORE instructions as a part of the address calculation. The base offset MUX 260 selects a base address that is summed with a logical address 262. The output is an extended address provided to an address latch 264 coupled to an external memory location. In some embodiments of the invention, implementation of the MMU 194 provides a plurality of benefits including speed increases during computation of the extended address, the ability to address more than 256 bytes from one MMU region, and the ability to address large address spaces without degradation of the base address. The base registers may also be explicitly specified by the programmer, rather than being implied by a programmer accessing a reserved area of memory.

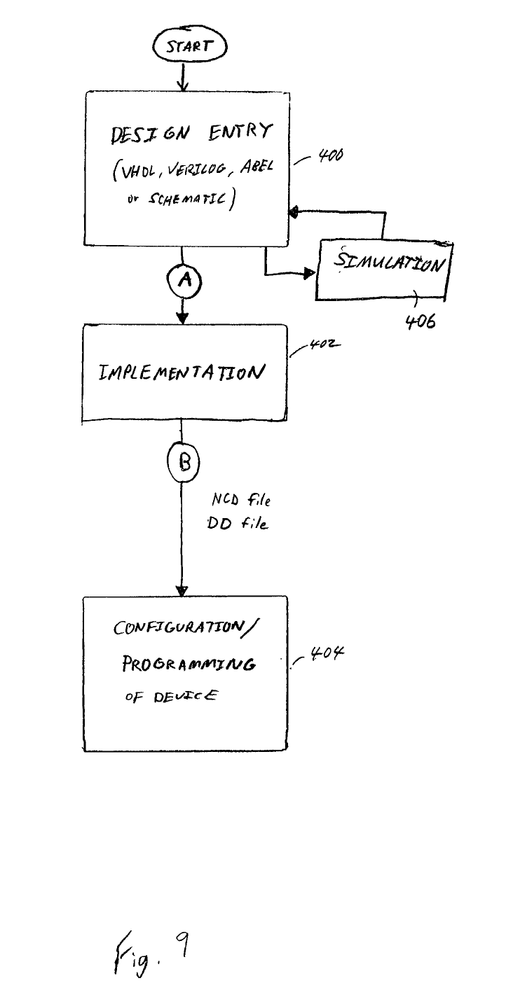

FIGS. 9-14 illustrate exemplary steps and processes related to implementation and programming of the communications core in FIG. 2 on families of programmable logic devices. Subsequent discussions are provided with reference to the Virtex™ and Spartan™ family of FPGA and CPLD devices (which, as noted, are available from Xilinx Incorporated). Nevertheless, the discussion is intended only as an example and the invention is not limited to implementation with Xilinx brand programmable devices or software tools.

FIG. 9 illustrates an exemplary flow overview for synthesizing a communications core, such as the core of FIG. 2, on a Xilinx programmable logic device. The steps include a design entry step 400, an implementation step 402, a programming step 404, and a simulation step 406, details of each will be described with reference to subsequent figures. Briefly however, design entry step 400 allows a designer to realize the communications core of FIG. 2 on a programmable device by creating the core architecture using schematics, text-based entries, or both. The entered design is synthesized and simulated at step 406 to verify the design parameters and constraints placed by the user or dictated by the capabilities of the target device. The implementation step 402 converts the logical design file format created in the design entry step 400 to a physical file format. The programming step 404 creates bit-stream data files from the implementation files and downloads the formatted data to the target programmable device.

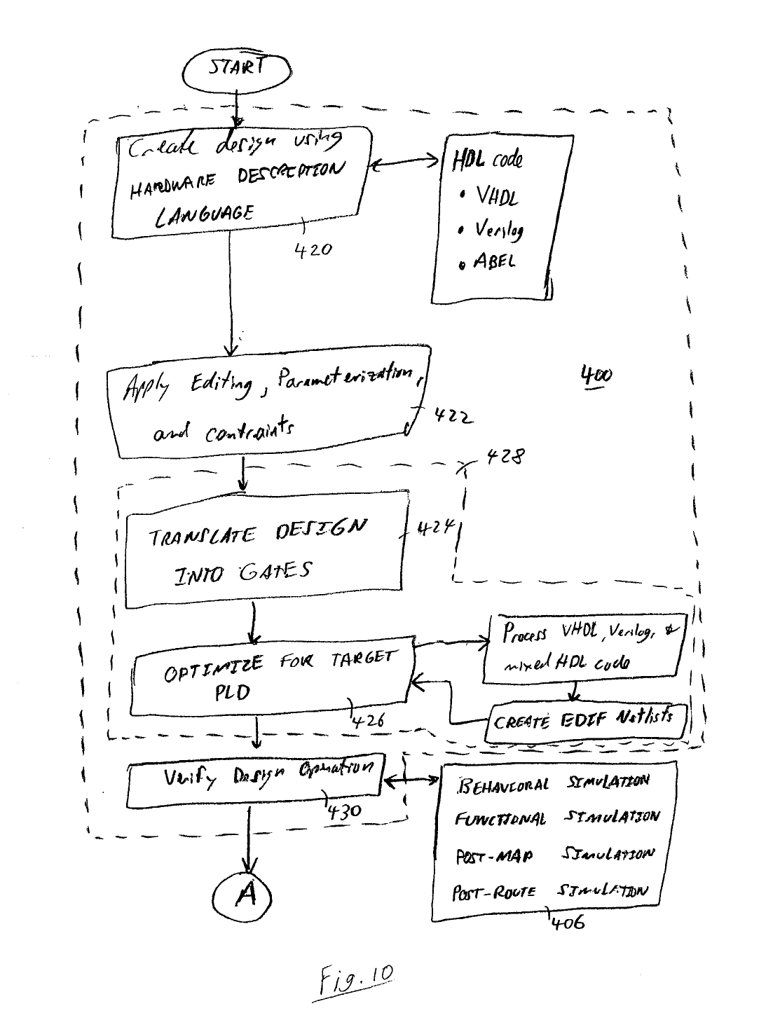

An exemplary illustration of the design entry step 400 is shown in FIG. 10. The design entry step 400 generally begins with a coding step 420 that includes representing a processor architecture, such as what is illustrated in FIG. 7, using Hardware Description Language (“HDL”) code or a combination of HDL code, schematics, and state diagrams. The HDL code source files may be implemented using one of a plurality of languages including Very High-Speed Integrated Circuits Hardware Description Language (“VHSIC” known as “VHDL”), Verilog, and ABEL. The language used may depend on the choice of programmable logic device. VHDL allows modeling of digital systems from an algorithmic level to a gate level and is capable of describing the parallel and serial behavior of a digital system with or without timing. Verilog is also hardware description language capable of modeling digital systems. ABEL is a high-level description language and compilation system. Designs implemented in ABEL may be converted to VHDL or Verilog using an HDL converter. At a parameterization step 422, constraints may be associated with a target device architecture by using a user constraint file (“UCF”), HDL code, or schematic. Constraints may indicate such things as placement, implementation, naming, directionality, grouping, initialization, and timing. However, as shown in FIG. 10 in step 422, constraints may be entered throughout the design process using a variety of tools. For example, the Integrated System Environment (“ISE”) from Xilinx supports constraint entry methods including an Xilinx constraints editor, a UCF, FPGA Express, and an XST constraint file to name a few. With continuing reference to FIG. 10, step 424 and step 426 are part of a synthesis step 428 that translates an HDL design into logic gates and optimizes the code for the target programmable device. The HDL code used to describe the design is processed and converted into appropriate electronic design interchange format (“EDIF”) files or native generic object (“NGO”) files that are read during the implementation step 402. A verification step 430 may invoke a plurality of simulations to check the operation of the processor design before and after implementation. The simulations may include a behavioral simulation to check the logic prior to synthesis, a functional simulation to check the logic after synthesis, a post-map simulation verifying the map of the logical description to logic and I/O cells in the target device, and a post-route simulation to verify the design meets the timing requirements set for the target device.

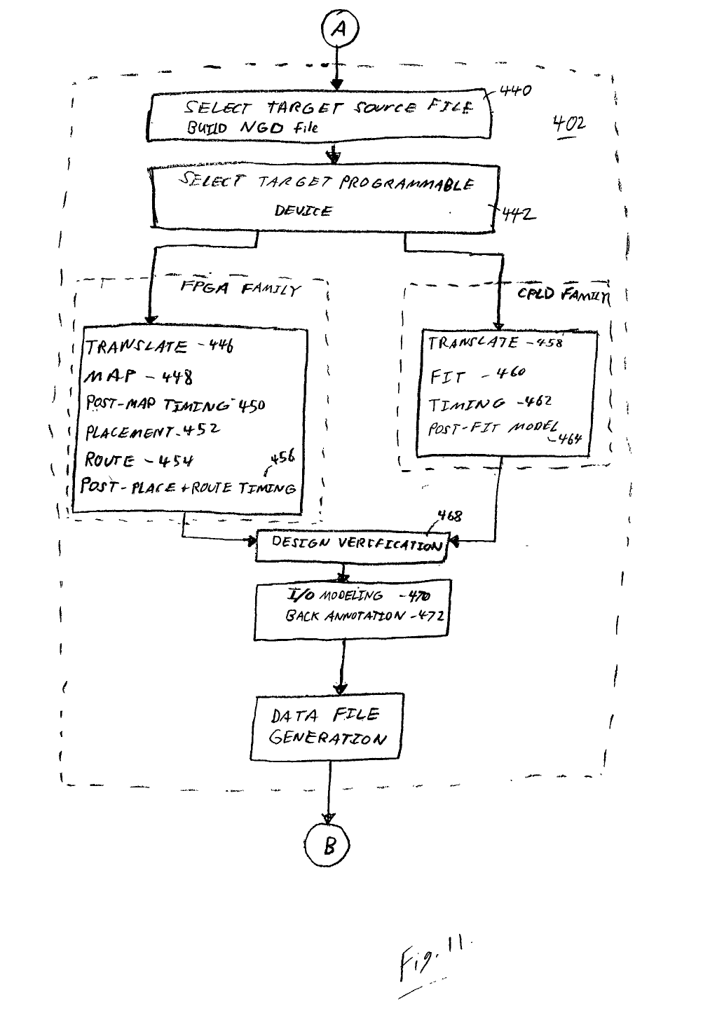

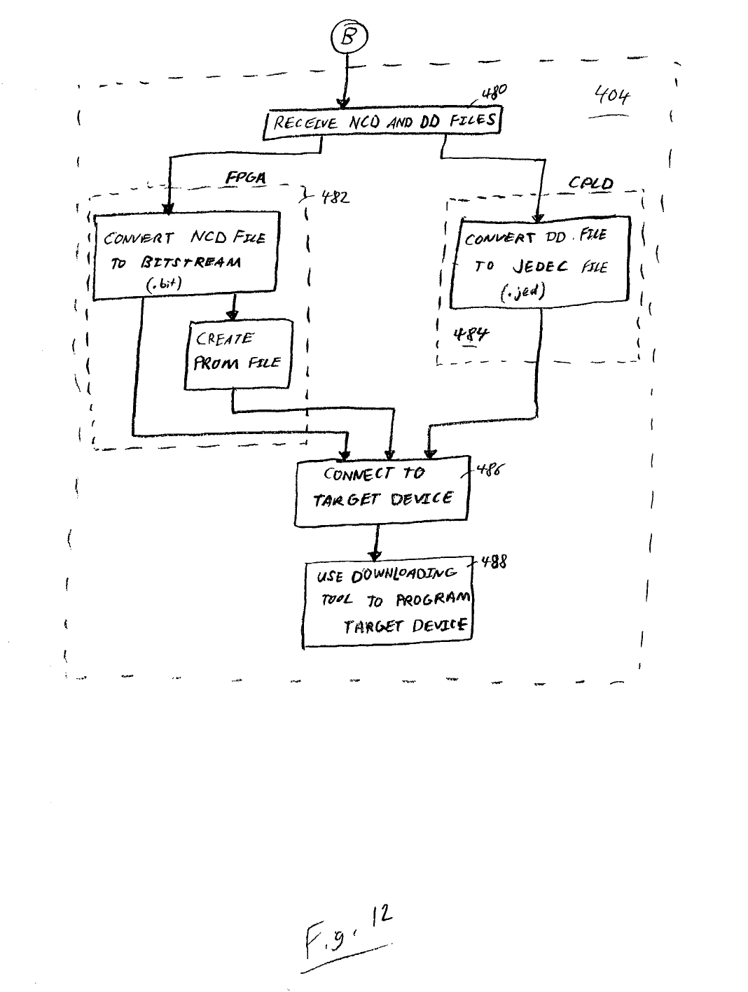

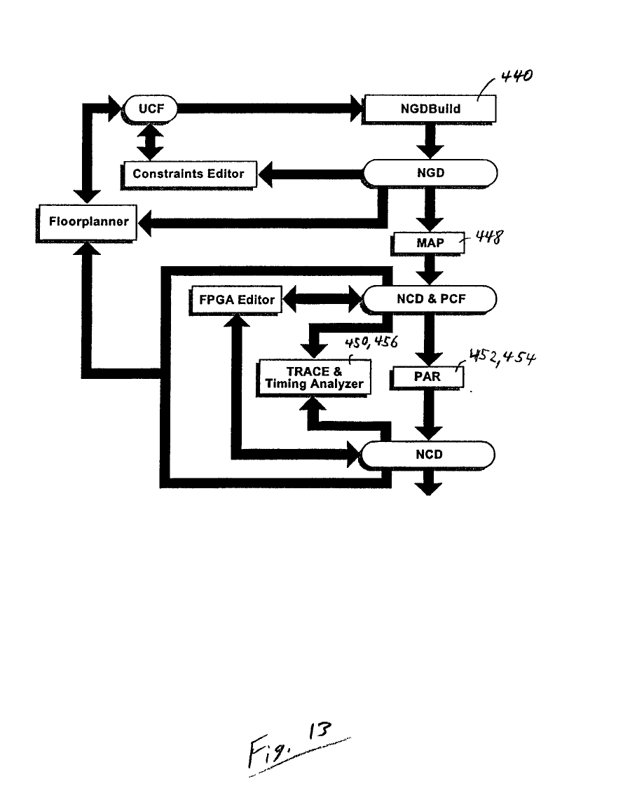

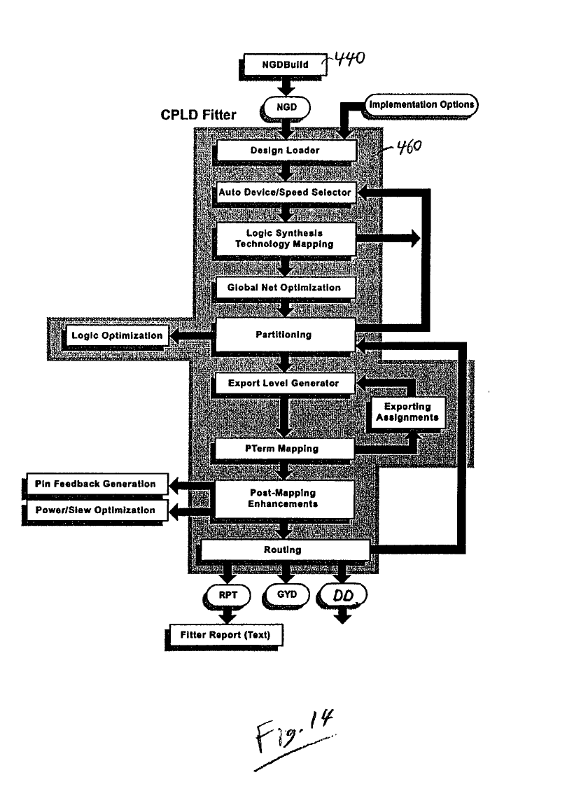

After the communications core, represented in FIG. 2, is entered and synthesized, implementation of the design converts the logical description into a physical file format that may be implemented in the selected target programmable device. Implementation may generically include the mapping or fitting of a logical design file to a specific programmable device, routing of the design to meet the layout of the target device, and generating a data bit-stream for programming the target device. More specifically, FIG. 11 illustrates steps that exemplify the general implementation step 402 in FIG. 9. At step 440, a target source file is selected for implementation, which may preferably include EDIF or NGO files generated in the design entry step 400. A target programmable device is selected at step 442 and may include, for this exemplary description, an FPGA or CPLD family of devices commercially available from Xilinx Incorporated. Implementation on an FPGA family device may include a translation step 446, a mapping step 448, a post-map timing step 450, a placement step 452, a routing step 454, and a post-place and route timing step 456. Implementation on a CPLD family device may include a translation step 458, a fitting step 460, a timing step 462, a post-fit model step 464, and an Input/Output (“I/O”) model step 466. Translation steps 446 and 458 may be similar such that in both steps, appropriate native generic database (“NGD”) files are generated. An NGD file may include a logical description of the design expressed in terms of the hierarchy used during entry step 400 and in terms of lower-level Xilinx primitives to which the hierarchy resolves. Further description of the above noted steps associated with FPGA and CPLD implementation is provided below with reference to FIGS. 13 and 14, respectively. The implementation flow illustrated in FIG. 12 further includes a design verification step 468 that may include functional and timing simulations, static timing analysis, and in-circuit verification. In addition, an I/O modeling step 470 and annotation step 472 provide description and analysis of device pin configurations. The output of implementation step 402 includes bit-stream data files generated for the selected programmable device. For example, the file formats for FPGA and CPLD devices may include netlist circuit description (“NCD”) and design database (“DD”) formats.

The process associated with implementation of a processor design, such as the exemplary communications core of FIG. 2, is illustrated for FPGA and CPLD devices in FIGS. 13 and 14, respectively. FIG. 13 illustrates an exemplary implementation process for a FPGA device including the NGD building step 440 through NCD file generation based on an integrated synthesis environment. Similarly, FIG. 14 illustrates an exemplary implementation process for a CPLD device.

Once the exemplary communications core (shown in FIG. 2) is implemented, the output files from the implementation process are modified and downloaded for operation on the target device. FIG. 13 illustrates exemplary steps in the device programming step 404 (of FIG. 9) including a file receiving step 480, conversion steps 482 and 484, a connection step 486, and a downloading step 488. More specifically, the receiving step 480 reads in the NCD and DD files generated during implementation and conversion steps 482 and 484 modify the data files to BIT and JED formats, respectively. In addition, step 482 may format the BIT file into a PROM file compatible with Xilinx and third-party PROM programmers. Connection is made to the selected target device in step 486 using, for example, an Xilinx Parallel Cable III or a MultiLINX cable, and the properly formatted data files are downloaded to the device in step 488.

It should be noted that the exemplary design entry, implementation, and device programming process is provided with reference to FPGA and CPLD devices and using ISE-4 software developed by Xilinx Incorporated. However, the exemplary communications core of FIG. 2 may be implemented on programmable devices from other manufacturers, and using alternative synthesis software such as Quartus II development software from the Altera Corporation. In addition, the ISE-4 software from Xilinx Incorporated includes additional features, such as reporting, power optimization, speed, partial implementation, and floor-planning features, which are shown for exemplary purposes but are not described. The above mentioned features, also including features not mentioned and those provided by alternative design synthesis tools, may be utilized with the exemplary communications core of FIG. 2.

It should also be understood that it may be possible to create multiple instantiations of a communications core on a programmable device by, in essence, repeating the steps noted above. The factors limiting the ability to do the same include the size of available memory and the size of the designed processor.

As can be seen from the above, the invention provides methods and systems of implementing a communications core. Various features and aspects of the invention are set forth in the following claims.

What is claimed is:

1. A programmable device for use in a communications network, the programmable device comprising:
a subsystem interconnect operable to connect the programmable device to computer;
a message processor coupled to the subsystem interconnect, the message processor having an instruction set architecture that includes a data path configured to reduce hardware requirements and increase memory management capabilities; and
a codec coupled to the message processor.

2. The programmable device as claimed in claim 1, wherein the programmable device also includes;
an instruction data buffer coupled to the message processor; and
a signal conditioner coupled to the codec.

3. The programmable device as claimed in claim 1, wherein the programmable device is re-programmable.

4. The programmable device as claimed in claim 1, wherein the message processor is operable to access external memory.

5. The communications network comprising:
a transmission media for exchanging data and information;
a plurality of terminals coupled to the transmission media and coupled to at least one subsystem operable to generate signals for transmission on the transmission media and to receive information from the transmission media;
a bus controller coupled to the transmission media and operable to generate and transmit at least one signal on the transmission media, whereby the at least one signal represents a command for the at least one subsystem coupled to at least one of said plurality of terminals,
wherein each of the plurality of terminals includes a programmable device operable to process data corresponding to a signal generated by the at least one subsystem or by the bus controller, having an instruction set architecture that includes a data path configured to minimize hardware requirements, and including
a message processor; and
a codec coupled to the message processor.

6. The communications network of claim 5, wherein the programmable device also includes
a subsystem interconnect;
a message processor;
a codec; and
an instruction data buffer;
wherein the message processor is coupled to the subsystem interconnect and operable to access memory located in at least one subsystem.

7. The communications network of claim 5, wherein a bus monitor is coupled to the transmission media and operable to store information based on transmitted data.

8. The communications network of claim 5, wherein one of the plurality of terminals may be designated as the bus monitor.

9. The communications network of claim 5, wherein the transmission media includes a twisted shielded pair transmission line having a main bus and a number of branches.

10. The communications network of claim 5, wherein the transmission media includes a wireless data transmission system.

11. The communications network of claim 5, wherein one of the plurality of terminals is designated as a bus controller.

12. The communications network of claim 5, wherein a terminal may be embedded in a subsystem.

13. A method of integrating a communications core on a programmable device using a design synthesis tool, the method comprising:
entering a communications core design having a reduced instruction set architecture;
implementing the communications core design for a designated target programmable device;
downloading information based on the communications core design to the target programmable device;
wherein the communications core design includes a message processor, a subsystem interconnect, and a codec.

14. A method of implementing a communications core protocol on a programmable device, the method comprising:
creating a communications core architecture in one or more files, each file having a logical design file format, the communications core architecture supporting a constant instruction size, at least two general purpose registers, and 16-bit, non-pipelined addressing and data communication;
verifying design parameters of the architecture;
converting the one or more files in a logical design file format to one or more files in a physical file format;
creating bit-stream data files; and
loading formatted data to a memory.

15. The method as claimed in claim 14, wherein the act of creating a communications core architecture include using an item selected from the group of schematics, text-based entries, or both.

16. The method as claimed in claim 14, wherein the act of creating a communications core architecture includes representing a processor architecture using hardware description language.

17. The method as claimed in claim 14, wherein the act of verifying design parameters includes one of the group of using a constraint file, HDL code, a schematic, or combination thereof.

18. The method as claimed in claim 14, wherein the act of verifying design parameters includes simulating a communications core having the communications core architecture.

19. The communications core implemented on a single programmable device, the communications core operable to provide communication interfaces, and to decode, encode, process, and buffer messages.

20. The communications core as claimed in claim 19, wherein the communications core is further operable to support a singular mode and a simultaneous mode of a bus controller.

21. The communications core as claimed in claim 20, wherein the communications core is further operable to support a monitor and one or more remote terminals.

22. The communications core having a predetermined protocol implemented on a single programmable device, the communications core configured to be programmed in one or more instances on the single programmable device and operable to decode, encode, message process, and buffer messages and to support a operations of a bus controller in singular and simultaneous modes.

23. The communication core as claimed in claim 22, the communications core further operable to condition signals.

24. The communications core as claimed in claim 22, wherein the predetermined protocol is a 1553 protocol.

25. The communications core as claimed in claim 22, wherein the predetermined protocol is a 1773 protocol.

26. A method of implementing a codec in a programmable device, the programmable device coupled to at least one subsystem and a communications network having a data bus and a bus controller, the method comprising:
receiving a signal from the data bus;
decoding the signal to extract information based on a command executable by the at least one subsystem;
receiving information from the at least one subsystem in response to the decoded signal received from the data bus;
encoding the information for transmission onto the data bus; and
transmitting an encoded signal receivable by the data bus.
